(19) United States
(12) Patent Application Publication
(10) Pub. No.: US 2023/0032265 A1
(43) Pub. Date: Feb. 2, 2023

(54) RESISTANCE WATER LAMP

(71) Applicant: Chin-Sheng YANG, Tainan City (TW)

(72) Inventor: Chin-Sheng YANG, Tainan City (TW)

(21) Appl. No.: 17/387,960

(22) Filed: Jul. 28, 2021

(51) Int. Cl. F21V 33/00; F21V 31/04; H05B 3/04; H05B 3/00; H05B 1/02

(52) U.S. Cl. CPC F21V 33/0028; F21V 31/04; H05B 3/04; H05B 3/0071; H05B 1/0244; F21V 31/005

(57) ABSTRACT

A resistance water lamp includes: a main body, made of plastic material, and being a transparent hollow three-dimensional type, low boiling point liquid filled in an inside thereof, and an accommodation tank, fixed to one side of the main body, an inside thereof provided with an electric control unit including at least one electric heater and power source, the electric heater positioned correspondingly to the side of the main body, and power thereof provided by the power source, the electric heater producing a thermistor effect and generating heat energy when the electric heater is energized, thereby driving the liquid inside the main body to generate relative flowing with the heat energy.

### (a) TECHNICAL FIELD OF THE INVENTION

The present invention relates to a water lamp, and more particularly to a structure allowing liquid to generate a dynamic effect with an electric heater.

### (b) DESCRIPTION OF THE PRIOR ART

Current people focus on the quality of life, and require a relaxed atmosphere and a sense of self-space design on both the design and layout of living spaces; the design and furnishings can be arranged with the help of general accessories, such as: paintings and calligraphy, lighting, tablecloths, decorations, candlesticks, and etc., where the light of lighting and candlesticks can more create an excellent atmosphere in the space.

For example, the lighting disclosed in U.S. Pat. No. 7,063,431 B2 applied by and approved for the applicant of the present invention mainly fills low boiling point liquid of dichloromethane in a vacuum glass tube, and the bottom end of the glass tube is provided with a circuit structure including at least one component that can be electrified to generate heat due to resistance effect. In this way, the bottom surface of the glass tube can receive the working heat source generated by the electric current through the resistance to reach the boiling point of the liquid in the glass tube to generate a decorative effect of bubbles. However, dichloromethane is a chloride, which is harmful to health and has varying degrees of impact on the environment. In addition, the liquid container is made of glass, and prone to fragmentation due to collision during manufacturing and handling, and glass lighting is also quite inconvenient when storing.

### SUMMARY OF THE INVENTION

To overcome the above disadvantages, the present invention proposes a resistance water lamp, comprising: a main body, made of plastic material, and being a transparent hollow three-dimensional type, low boiling point liquid filled in an inside thereof, and an accommodation tank, fixed to one side of the main body, an inside thereof provided with an electric control unit including at least one electric heater and power source, the electric heater positioned correspondingly to the side of the main body, and power thereof provided by the power source, the electric heater producing a thermistor effect and generating heat energy when the electric heater is energized, thereby driving the liquid inside the main body to generate relative flowing with the heat energy.

When the heater is energized, it will produce a thermistor effect to generate heat energy, thereby driving the low boiling point liquid to create relative flowing with the heat energy, and forming a water lamp structure having dynamic changes.

### BRIEF DESCRIPTION OF THE DRAWINGS

FIG. 1 is a perspective view of the present invention;

FIG. 2 is an exploded view of the present invention;

FIG. 3 is a cross-sectional view of the present invention; and

FIG. 4 is a cross-sectional view of another preferred embodiment of the present invention.

### DETAILED DESCRIPTION OF THE PREFERRED EMBODIMENTS

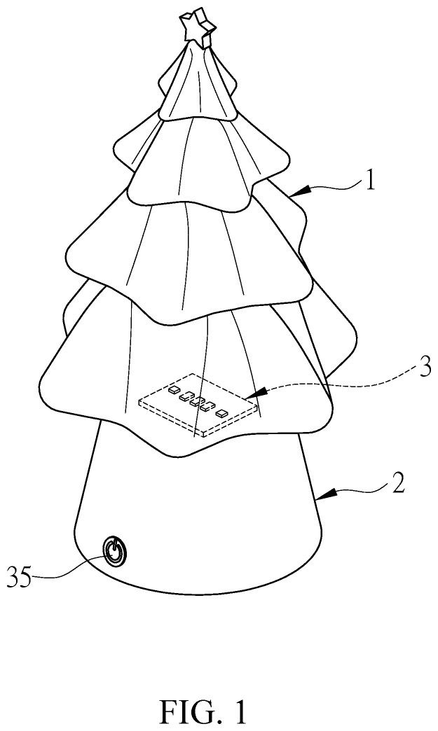

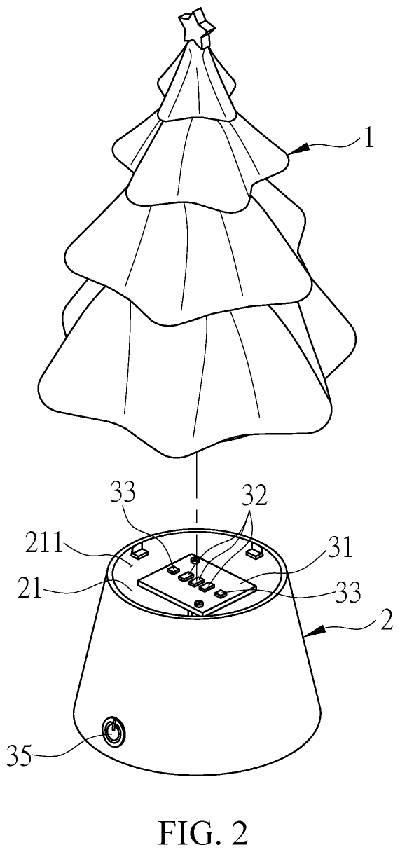

Referring to FIGS. 1 to 3, a resistance water lamp, in a preferred embodiment, mainly includes a main body 1 and accommodation tank 2, where the main body 1 is made of plastic material by means of injection or blow molding, and is a transparent hollow three-dimensional shape. The main body 1 includes a shell 11 and bottom cover 12, where the bottom of the shell 11 has an opening 111 facing downward, and the bottom cover 12 is configured on the bottom of the shell 11 and adapted to seal the opening 111; the inside of the shell 11 is filled with low boiling point liquid, which is a mixed solution of water and calcium nitrate in an appropriate proportion. In the embodiment, the shell 11 is exemplified as a Christmas tree body to describe, but the present invention is not so limited, it can be a sphere, a square, a polyhedron or other natural objects. In addition, glitter powder and/or sequins can be added to the liquid, so that the flow of the liquid can bring different visual changes to consumers.

The accommodation tank 2 is configured with an opening 21, and fixed to one side of the main body 1 with the opening 21; the inside of the accommodation tank 2 is configured with an electric control unit 3 including a circuit board 31, at least one electric heater 3, at least one light-emitting element 31 and power source 34, where the electric heater 32, light-emitting element 33 and power source 34 are respectively electrically connected with the circuit board 31, which can control the flicker frequency and light color change of the light-emitting element 33 through a circuit design. However, the circuit design can be changed in many ways and is not the focus of the present invention, so the detail thereof is omitted here.

The power source 34 is adapted to provide the electric heater 32 and light-emitting element 33 with power, and the present invention does not limit the type of the power source 34; it can be mains or battery. Furthermore, the present invention also does not limit the number of the electric heaters 32 and the one of the light-emitting elements 33, and they can be increased depending on the structural design. In the embodiment, a plurality of electric heaters 32 and a plurality of light-emitting elements 33 are shown in the figures, but the present invention is not so limited. In addition, the electric heater 32 may be an electric heating wire, electric heating piece, cement resistor or incandescent bulb.

As mentioned above, in order to directly conduct the thermal energy of the electric heater 32 and the light-emitting element 33 to the side of the main body 1, the electric heater 32 and light-emitting element 33 are preferably formed a close contact with the side of the main body 1. In addition, the electric control unit 3 further includes a switch 35, through which the power source (mains or battery) can be conducted and closed. Furthermore, each of the electric heaters 32 is allowed to be energized to generate heat energy, and the circuit board control the time sequence of the light color changes of each of the light-emitting elements 33.

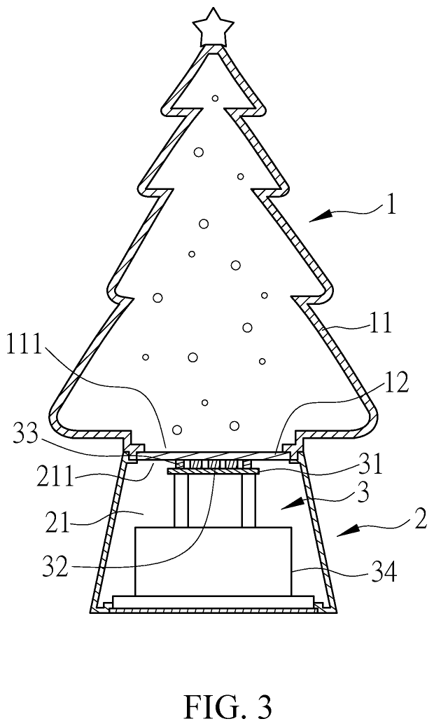

Referring to FIG. 3, each of the electric heaters 32 will produce the thermistor effect and generate heat energy to drive the liquid inside the main body 1 to create dynamic effects of bubble flow when the power source 34 is energized. In addition, the flowing liquid is then irradiated by each of the light-emitting elements 33 to form a water lamp structure with dynamic light and shadow changes. It is worth mentioning that, the present invention uses an appropriate ratio of calcium nitrate and water, capable of reducing harm to health and influence to the environment, and the main body 1 is made of plastic material, having the advantages of reducing collision damage during handling and being convenient for storage compared to the prior art glass products.

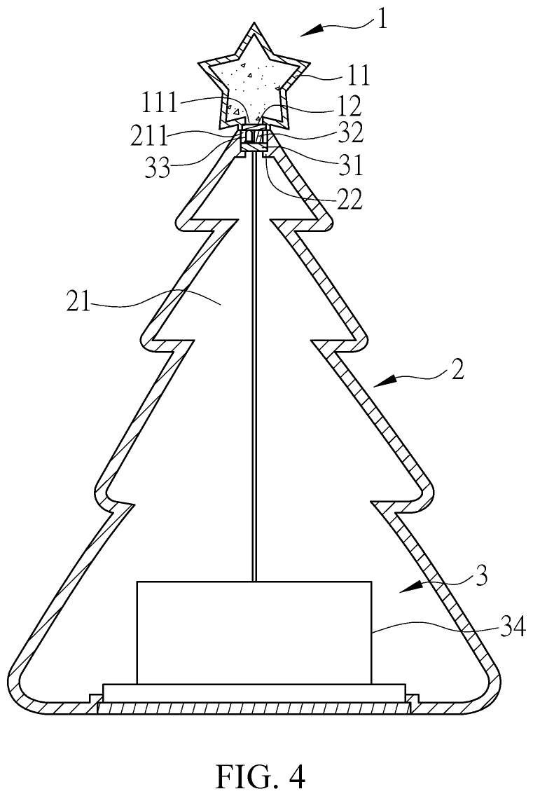

Next, referring to FIG. 4, the main body 1, in another preferred embodiment, is a star body, inside which low boiling point liquid is filled, where the liquid is mixed solution of an appropriate ration of water and calcium nitrate; the accommodation tank 2 is a Christmas tree-shaped body, fixed to one side of the main body 1, where the wall of the accommodation tank 2 adjacent to the opening 21 is provided with a shoulder 22, and the circuit board 31 of the electric control unit 3 is mounted on the shoulder 22 to make the electric heater 32 and light-emitting element 33 attach to the side of the main body 1, thereby allowing them to drive the liquid inside the main body 1 to generate the dynamic effects of flowing bubbles with the heat energy produced by them.

As mentioned above, the shoulder 22, in the embodiment, is adapted to mount and fix the electric control unit 3, allowing the electric heater 32 to be close to the bottom of the main body 1. Therefore, any structure that can be used to fix the electronic control unit 3 or make the electric heater 32 close to the bottom of the water lamp body 1 falls in the scope of this present invention.

I claim:

1. A resistance water lamp, comprising:
a main body, made of plastic material, and being a transparent hollow three-dimensional type, low boiling point liquid filled in an inside thereof; and
an accommodation tank, fixed to one side of said main body, an inside thereof provided with an electric control unit including at least one electric heater and power source, said electric heater positioned correspondingly to said side of said main body, and power thereof provided by said power source, said electric heater producing a thermistor effect and generating heat energy when said electric heater is energized, thereby driving said liquid inside said main body to generate relative flowing with said heat energy.

2. The lamp according to claim 1, wherein said liquid is a solution of water mixed with calcium nitrate.

3. The lamp according to claim 1, wherein said electric control unit further comprises a control board, at least one light-emitting element and a switch, said electric heater, light-emitting element and switch are respectively in electric connection with said circuit board, and said light-emitting element emits light toward said bottom of said main body.

4. The lamp according to claim 1, wherein said electric heater is an electric heating wire or electric heating piece.

5. The lamp according to claim 1, wherein said electric heater is a cement resistor.

6. The lamp according to claim 1, wherein said electric heater is an incandescent bulb.

7. The lamp according to claim 1, wherein said main body comprises a shell and bottom cover, a bottom of said shell has an opening facing downward, and said bottom cover is configured on said bottom of said shell to seal said opening of said shell.
